(19) United States
(12) Patent Application Publication
(10) Pub. No.: US 2007/0297539 A1
(43) Pub. Date: Dec. 27, 2007

(54) METHOD AND APPARATUS FOR RECEIVING DATA IN A COMMUNICATION SYSTEM

(75) Inventors: Chung-Ryul CHANG, Yongin-si (KR); Jang-Hoon Yang, Seongnam-si (KR)

Correspondence Address: Jefferson IP Law, LLP, 1730 M STREET, NW, SUITE 807, WASHINGTON, DC, 20036, US

(73) Assignee: Samsung Electronics Co., LTD., Suwon-city (KR)

(21) Appl. No.: 11/842,347

(22) Filed: Aug. 21, 2007

(30) Foreign Application Priority Data
Jun. 21, 2006 (KR) 10-2006-79036

(51) Int. Cl. H04L 27/06

(52) U.S. Cl. 375/340

(57) ABSTRACT

An apparatus and method for receiving data by a receiver in a communication system are provided. The data reception method includes receiving data from a transmitter over a transmission region including multiple tiles and measuring noise of each of predetermined tiles among the multiple tiles, calculating a total variance of noises of the measured tiles and a variance of tiles according to the measured noises, comparing the calculated total variance with a first threshold, and comparing the variance of each tile with a second threshold, calculating a Log Likelihood Ratio (LLR) using a value according to the comparison result and performing decoding using the calculated LLR. Accordingly, the reception performance is improved by minimizing an influence of noises due to ICI in a communication system having a multi-cell configuration.

### PRIORITY

This application claims the benefit under 35 U.S.C. §119(a) of a Korean patent application filed in the Korean Intellectual Property Office on Aug. 21, 2006 and assigned Serial No. 2006-79036, the entire disclosure of which is hereby incorporated by reference.

### BACKGROUND OF THE INVENTION

1. Field of the Invention

The present invention relates generally to a communication system. More particularly, the present invention relates to a data reception method and apparatus for minimizing Inter-Cell Interference (ICI) in a communication system having a multi-cell configuration.

2. Description of the Related Art

Intensive research is being conducted on a next generation communication system that provides high-speed services having various Quality-of-Service (QoS) classes to users. Because a Broadband Wireless Access (BWA) communication system, which is a current communication system, includes multiple cells and the multiple cells included in the communication system share limited resources, i.e. frequency resources, code resources, time slot resources, etc., some different cells reuse the same resources, causing ICI between the multiple cells, especially between adjacent cells. However, in the multi-cell communication system, while the reuse of frequency resources, code resources, time slot resources, etc. by different cells may cause performance degradation due to the ICI, it may increase the entire capacity of the multi-cell communication system.

The ICI is considerably high in a multi-cell communication system using a frequency reuse factor of 1. More specifically, in a multi-cell communication system where multiple cells are provided and the multiple cells share a frequency band, in order to reuse frequency resources while reducing interference between the cells, the frequency band is divided into as many sub-frequency bands as the frequency reuse factor. The sub-frequency bands are allocated to as many cells as the number of the sub-frequency bands, including a serving cell, among the multiple cells, and some cells among the remaining cells except for the cells to which the sub-frequency bands are allocated reuse the sub-frequency bands taking into account interference to/from other cells.

In the multi-cell communication system, as a frequency reuse rate is lower, i.e. as the frequency reuse factor exceeds 1, the ICI decreases but the amount of frequency resources available in one cell decreases, thus causing a reduction in the entire capacity of the multi-cell communication system. On the contrary, when the frequency reuse factor is 1, i.e. when all cells constituting the multi-cell communication system use the same frequency band, the ICI increases, but the amount of frequency resources available in one cell also increases, causing an increase in the entire capacity of the multi-cell communication system.

When an Institute of Electrical and Electronics Engineers (IEEE) 802.16 communication system employing Orthogonal Frequency Division Multiplexing (OFDM)/Orthogonal Frequency Division Multiple Access (OFDMA) includes multiple cells, ICI between the multiple cells occurs as described above. In particular, the IEEE 802.16 communication system generates subchannels in the entire frequency band, and the generated subchannels are set in different ways for the individual cells, to average their ICI. For example, one subchannel of one arbitrary cell uniformly affects all subchannels of another adjacent cell, and if a loading rate of the arbitrary one cell increases, ICI of all the subchannels of another adjacent cell increases on average. Therefore, there is a need for a data reception scheme for increasing data reception performance of the system by minimizing an influence of noise due to ICI in the multi-cell environment.

### SUMMARY OF THE INVENTION

An aspect of the present invention is to address at least the above problems and/or disadvantages and to provide at least the advantages described below. Accordingly, an aspect of the present invention is to provide a method and apparatus for receiving data in a communication system.

Another aspect of the present invention is to provide a data reception method and apparatus for improving reception performance by minimizing an influence of noise due to ICI in a communication system having a multi-cell configuration.

According to one aspect of the present invention, a method for receiving data by a receiver in a communication system is provided. The data reception method includes receiving data from a transmitter over a transmission region including multiple tiles and measuring noise of each of predetermined tiles among the multiple tiles, calculating a total variance of noise of the predetermined tiles and a variance of each of the predetermined tiles according to the measured noise, comparing the calculated total variance with a first threshold and comparing the variance of each tile with a second threshold, calculating a Log Likelihood Ratio (LLR) using a value according to the comparison result and performing decoding using the calculated LLR.

According to another aspect of the present invention, a method for receiving data by a receiver in a communication system is provided. The data reception method includes receiving data including a plurality of tiles from a transmitter over a transmission region, measuring noise of two or more of the plurality of tiles, calculating a total variance of noise of the two or more tiles and a variance of each of the two or more tiles according to the measured noise, comparing the calculated total variance with a first threshold, comparing the variance of each of the two or more tiles with a second threshold, calculating a Log Likelihood Ratio (LLR) using a predetermined value according to the comparison result; and decoding the received data using the calculated LLR.

According to another aspect of the present invention, an apparatus for receiving data in a communication system is provided. The data reception apparatus includes a measurer for receiving data from a transmitter over a transmission region including multiple tiles and for measuring noise of tiles among the multiple tiles, a first calculator for calculating a total variance of noise of the measured tiles and a variance of each of the measured tiles according to the measured noise, a decider for comparing the calculated total variance with a first threshold and comparing the variance of each tile with a second threshold, and a second calculator for calculating a Log Likelihood Ratio (LLR) using a value according to the comparison result.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 is a schematic diagram illustrating a configuration of a conventional IEEE 802.16 communication system;

FIG. 2 is a schematic diagram illustrating a structure of a subchannel in a communication system according to an exemplary embodiment of the present invention;

FIG. 3 is a schematic diagram illustrating a structure of a receiver in a communication system according to an exemplary embodiment of the present invention; and

FIG. 4 is a diagram illustrating an operation of a receiver in a communication system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well known functions and configurations are omitted for clarity and conciseness.

Exemplary embodiments of the present invention provide a method and apparatus for receiving data in a communication system, for example, an Institute of Electrical and Electronics Engineers (IEEE) 802.16 communication system, which is a Broadband Wireless Access (BWA) communication system and which standard is hereby incorporated by reference. Although an exemplary embodiment of the present invention will be described herein with reference to an IEEE 802.16 communication system employing Orthogonal Frequency Division Multiplexing (OFDM)/Orthogonal Frequency Division Multiple Access (OFDMA), by way of example, the data reception method and apparatus provided by the present invention can also be applied to other communication systems.

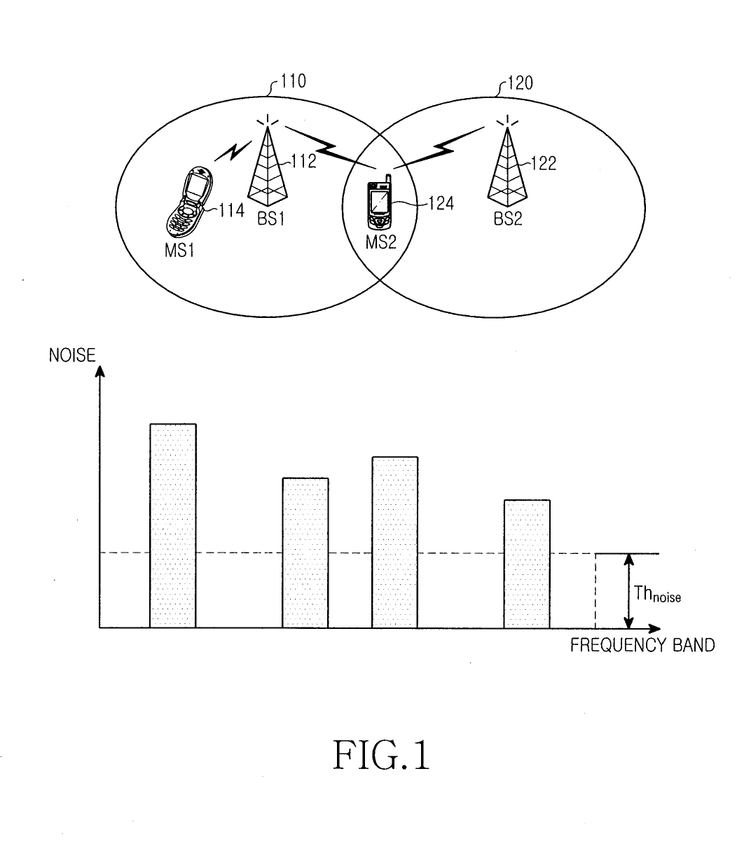

In addition, exemplary embodiments of the present invention provide a data reception method and apparatus between a transmitter, e.g. Base Station (BS) and a receiver, e.g. Mobile Station (MS) for receiving a communication service from the transmitter in a communication system having a multi-cell configuration. An exemplary embodiment of the present invention, described below, provides a data reception method and apparatus for improving data reception performance by minimizing Inter-Cell Interference (ICI) in a communication system having a multi-cell configuration. Further, an exemplary embodiment of the present invention provides a data reception method and apparatus for improving data reception performance by decoding data after measuring noise caused by ICI in a signal received from a transmitter and calculating a Log Likelihood Ratio (LLR) according to the measured noise. With reference to FIG. 1, a description will now be made of a communication system having a multi-cell configuration.

FIG. 1 is a schematic diagram illustrating a configuration of a conventional IEEE 802.16 communication system.

Referring to FIG. 1, the communication system has a multi-cell configuration, i.e. has a cell #1 110 and a cell #2 120, and includes a BS1 112 and a BS2 122 in charge of the cells 110 and 120, an MS1 114 that is located in the cell #1 110 and receives a communication service from the BS1 112, and an MS2 124 that is located in the cell #2 120 and receives a communication service from the BS2 122. For convenience, an exemplary embodiment will be explained wherein the signal exchange between the BSs 112 and 122, and the MSs 114 and 124 is achieved using OFDM/OFDMA.

When the MS1 114 and the MS2 124, especially the MS2 124 located in the boundary of the cell #2 120 exchanges data with the BS2 122, it suffers from ICI. As described above, MSs located in the same cell are allocated a predetermined frequency band from the entire available frequency band. When the MSs located in the cell exchange data with the BS over the allocated frequency band, ICI noise may occur in the allocated frequency band, and if the ICI is high in strength, the noise in the allocated frequency band are higher in strength than a noise threshold Thₙₒᵢₛₑ as shown in FIG. 1. A receiver, for receiving data from a transmitter over a predetermined frequency band, calculates an LLR using the noise in the predetermined frequency band and then decodes data depending on the calculated LLR. A detailed description will now be made of a scheme of measuring ICI noise and receiving data depending on the measurement result in a communication system according to an embodiment of the present invention.

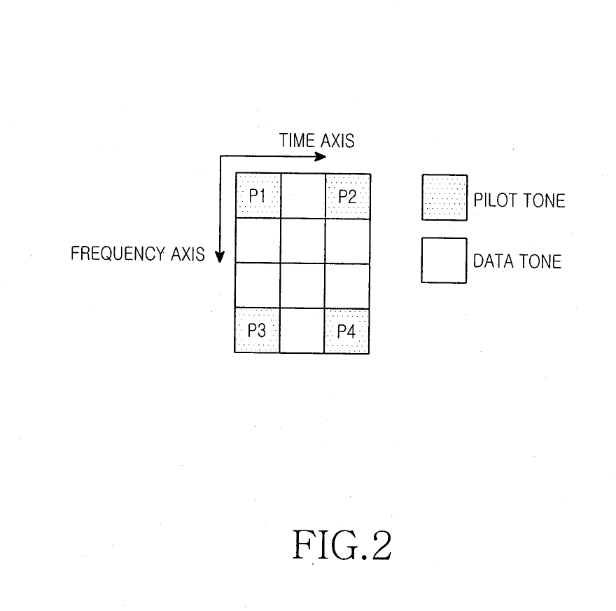

FIG. 2 is a schematic diagram illustrating a structure of a subchannel in a communication system according to an exemplary embodiment of the present invention. Shown in FIG. 2 is a schematic diagram illustrating a structure of a Partial Usage of Subchannels (PUSC) subchannel among a subchannel based on PUSC and a subchannel based on Full Usage of Subchannels (FUSC) in an IEEE 802.16 communication system. Although an exemplary embodiment of the present invention will be described with reference to the structure of the PUSC subchannel, the data reception method and apparatus provided by exemplary embodiments of the present invention can be applied not only to the FUSC subchannel structure but also to various other subchannel structures.

Referring to FIG. 2, the PUSC subchannel includes tiles wherein one tile includes 4 consecutive subcarriers along the frequency axis and 3 consecutive symbols along the time axis. The frequency domain is divided into subchannels, each of which is a bundle of subcarriers, and the time domain is divided into symbols. A receiver is allocated resources in units of slots given by a region where one subchannel occupies a symbol.

The tile includes pilot tones and data tones, and the receiver receives a pilot signal over 4 pilot tones P1, P2, P3 and P4 in one tile and receives the data transmitted by a transmitter over 8 data tones in one tile. When the receiver receives data from the transmitter in this manner, it measures noise of the tile by measuring strength of the pilot signal. The noise of the tile can be expressed as Equation (1).

$${NI}_{i , j} = \frac{1}{4} ( {\vert {P}_{i , j , 1} - {P}_{i , j , 2} \vert}^{2} + {\vert {P}_{i , j , 3} - {P}_{i , j , 4} \vert}^{2} ) \qquad ( 1 )$$

In Equation (1), NI_{i,j} denotes noise of a j^{th} antenna and an i^{th} tile, P_{i,j,k} denotes strength of a pilot signal received through a j^{th} antenna, an i^{th} tile and a k^{th} pilot tone, and ¼ is a constant defined on the assumption that one tile includes 4 pilot tones as shown in FIG. 2.

Thereafter, the receiver measures noise of each tile and then calculates the total mean of the noise of each tile, i.e. noise means of all tiles, using the measured noise. The total mean of the noise of each tile can be expressed as Equation (2).

$${NI}_{mean} = \frac{1}{{N}_{i} \cdot {N}_{j}} {\sum }_{i = 1}^{{N}_{i}} {\sum }_{j = 1}^{{N}_{i}} {NI}_{i , j} \qquad ( 2 )$$

In Equation (2), NIₘₑₐₙ denotes a noise mean of all tiles and antennas, NIᵢ denotes the total number of tiles, and NIⱼ denotes the total number of antennas. After calculating the noise mean of all tiles in this manner, the receiver calculates the total variance using the noise mean, and calculates a variance of noise of each tile. The total variance can be expressed as Equation (3).

$${NI}_{var} = \frac{1}{{N}_{i} \cdot {N}_{j}} {\sum }_{i = 1}^{{N}_{i}} {\sum }_{j = 1}^{{N}_{i}} {\vert {NI}_{i , j} - {NI}_{mean} \vert}^{2} \qquad ( 3 )$$

In Equation (3), NIᵥₐᵣ denotes the total variance, and |NI_{i,j}−NIₘₑₐₙ|² denotes a variance of each tile, i.e. a variance of a j^{th} antenna and an i^{th} tile.

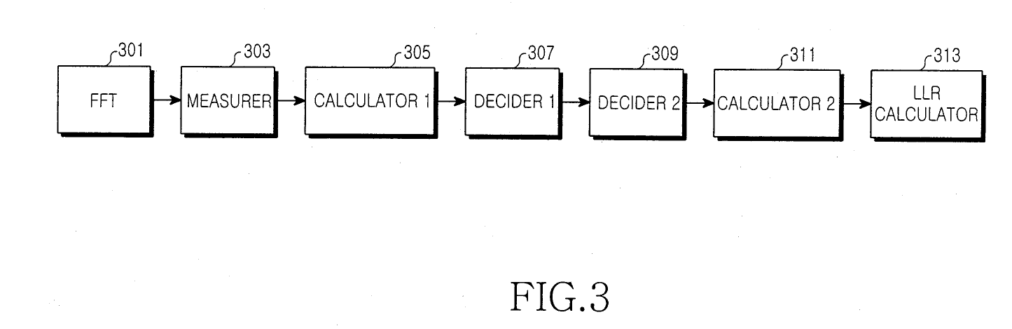

After measuring the noise of each tile and calculating the total mean, the total variance and the variance of each tile according to the measured noise, the receiver compares the total variance with a first threshold to decide an ICI level of a corresponding slot in a time zone of the subchannel, and compares the variance of each tile with a second threshold to decide an ICI level of each tile. Thereafter, the receiver calculates an LLR using noise according to the decision results, and decodes the data received from the transmitter, using the calculated LLR. In an exemplary embodiment, the first threshold and the second threshold may be preset by the system and/or user according to the communication environment and/or system environment. With reference to FIG. 3, a detailed description will now be made of a structure of a receiver in a communication system according to an exemplary embodiment of the present invention.

FIG. 3 is a schematic diagram illustrating a structure of a receiver in a communication system according to an exemplary embodiment of the present invention.

Referring to FIG. 3, the receiver includes a Fast Fourier Transform (FFT) unit 301 for FFT-transforming a signal received from a transmitter, a measurer 303 for measuring noise of each tile as described in Equation (1), a first calculator 305 for calculating the total mean of each tile, the total variance and a variance of each tile as described in Equation (2) and Equation (3), a first decider 307 for comparing the total variance calculated by the first calculator 305 with a first threshold to decide ICI of a corresponding slot, a second decider 309 for comparing the variance of each tile, calculated by the first calculator 305, with a second threshold to decide ICI of a corresponding tile, a second calculator 311 for calculating a noise mean of the ICI-free tile, and an LLR calculator 313 for calculating an LLR using noise according to the decision results of the first decider 307 and the second decider 309.

More specifically, the measurer 303 measures strength of a pilot signal transmitted over pilot tones of a subchannel, and measures noise of each tile depending on the measured pilot signal using Equation (1). The first calculator 305 calculates the total mean of noise measured by the measurer 303 as described in Equation (2), calculates the variance of each tile using the calculated total mean as described in Equation (3), and calculates the total variance of each tile.

The first decider 307 compares the total variance calculated by the first calculator 305 with the first threshold and decides an ICI level in a corresponding slot according to the comparison result. In other words, if the total variance is greater than the first threshold, the first decider 307, or the receiver, decides that the corresponding slot is a high-ICI slot, i.e. decides that the tile in the corresponding slot is a high-ICI tile. However, if the total variance is less than the first threshold, the first decider 307, or the receiver, decides that the tile in the corresponding slot is a low-ICI tile. The second decider 309 compares the variance of each tile, for the high-ICI tile decided according to the decision result of the first decider 307, with the second threshold, and decides an ICI level in the corresponding tile according to the comparison result. If the variance of the corresponding tile is greater than the second threshold, the second decider 309, deciding the corresponding tile as a high-ICI tile, transfers to the LLR calculator 313 noise of the corresponding tile of a variance being greater than the second threshold so that the LLR calculator 313 calculates an LLR using noise of the corresponding tile of the variance being greater than the second threshold. In this case, the second decider 309 stores an index of the corresponding tile of the variance being greater than the second threshold so that the LLR calculator 313 calculates an LLR using the noise of the corresponding tile of the variance being greater than the second threshold, and then the LLR calculator 313 calculates an LLR depending on the noise of the corresponding tile using the stored index. The noise of the corresponding tile of the variance being greater than the second threshold can be expressed as Equation (4).

$${NI}_{i} = \frac{1}{{N}_{j}} {\sum }_{j = 1}^{{N}_{i}} {NI}_{i , j} \qquad ( 4 )$$

In Equation (4), NIᵢ denotes noise of a corresponding i^{th} tile of a variance being greater than the second threshold.

If the variance of the corresponding tile is less than the second threshold according to the decision result of the second decider 309, the second calculator 311, deciding the corresponding tile as a low-ICI tile, calculates a noise mean of a tile, being less than the second threshold. In addition, the second calculator 311 transfers to the LLR calculator 313 the calculated noise mean of the tile, being less than the second threshold so that the LLR calculator 313 calculates an LLR using the calculated noise mean of the tile, being less than the second threshold. The noise mean of the tile, being less than the second threshold, can be calculated using Equation (2).

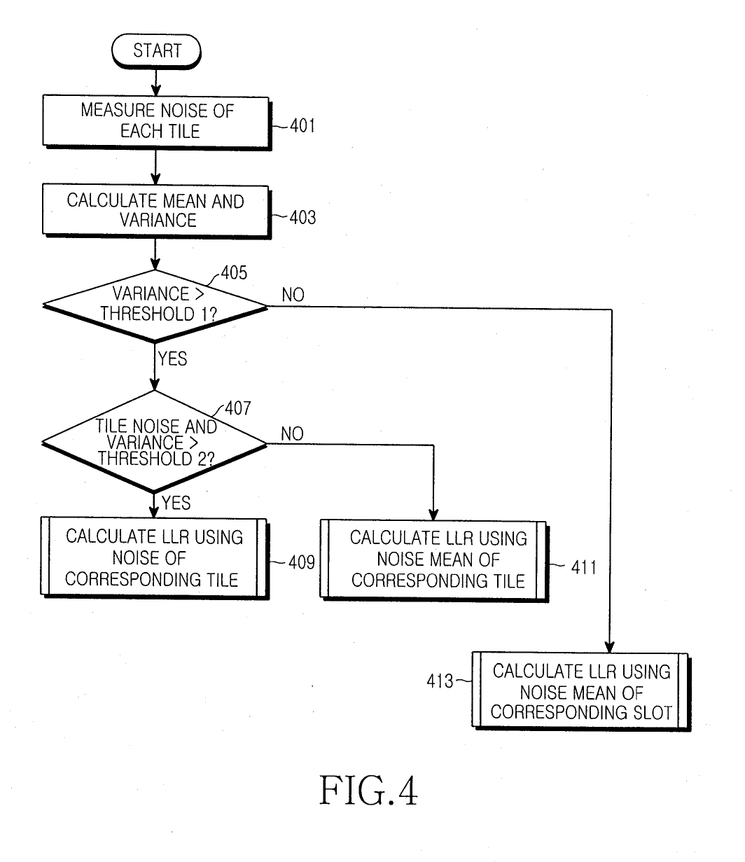

The LLR calculator 313 calculates an LLR using the input noise according to the decision results of the first decider 307 and the second decider 309. With reference to FIG. 4, a detailed description will now be made of an operation of a receiver in a communication system according to an exemplary embodiment of the present invention.

FIG. 4 is a diagram illustrating an operation of a receiver in a communication system according to an exemplary embodiment of the present invention.

Referring to FIG. 4, in step 401, the receiver measures strength of a pilot signal, transmitted over pilot tones of a subchannel, and measures noise of each tile depending on the measured pilot signal using Equation (1). Thereafter, in step 403, the receiver calculates the total mean of the noise measured in step 401 as described in Equation (2), calculates a variance of each tile using the calculated total mean as described in Equation (3), and calculates the total variance of each tile. The total mean of each tile, the total variance, and the variance of each tile have been described above.

In step 405, the receiver compares the calculated total variance with a first threshold (Threshold 1), and decides an ICI level in a corresponding slot according to the comparison result. That is, if the total variance is greater than the first threshold as a result of the comparison in step 405, the receiver decides that the corresponding slot is a high-ICI slot, i.e. decides that the tile in the corresponding slot is a high-ICI tile. In step 407, the receiver compares the variance of each tile, for the high-ICI tile, with a second threshold (Threshold 2), and decides an ICI level in the corresponding tile according to the comparison result. If the variance of the corresponding tile is greater than the second threshold as a result of the decision in step 407, the receiver proceeds to step 409, deciding the corresponding tile as a high-ICI tile. In step 409, the receiver calculates an LLR using the noise of the corresponding tile of the variance being greater than the second threshold, and decodes data received from a transmitter using the calculated LLR.

However, if the variance of the corresponding tile is less than the second threshold as a result of the decision in step 407, the receiver proceeds to step 411, deciding the corresponding tile as a low-ICI tile. In step 411, the receiver calculates an LLR using the noise mean of the tile, being less than the second threshold, and decodes data received from the transmitter using the calculated LLR. If there are multiple corresponding tiles, the receiver repeatedly performs step 407 as many times as the number of the corresponding tiles, compares the variance of each tile with the second threshold, and then proceeds to step 411 according to the comparison result. Thereafter, in step 411, the receiver stores noise of the tile, being less than the second threshold, calculates a noise mean of the tile, being less than the second threshold, using the stored noise, and calculates an LLR using the calculated noise mean.

If the total variance is less than the first threshold as a result of the comparison in step 405, the receiver proceeds to step 413, deciding that the tile in the corresponding slot is a low-ICI tile. In step 413, the receiver calculates an LLR using a noise mean of the corresponding low-ICI slot, and decodes data received from the transmitter using the calculated LLR.

As is apparent from the foregoing description, exemplary embodiments of the present invention correctly estimate an influence of noise due to ICI in the communication system having a multi-cell configuration, thereby decoding data after calculating an LLR with the influence of noise minimized. As a result, the data reception performance can be improved.

While the invention has been shown and described with reference to exemplary embodiments thereof, it will be understood by those skilled in the art that various changes in form and details may be made therein without departing from the spirit and scope of the invention as defined by the appended claims and their equivalents.

What is claimed is:

1. A method for receiving data by a receiver in a communication system, the method comprising:
receiving data from a transmitter over a transmission region including multiple tiles;
measuring noise of each of predetermined tiles among the multiple tiles;
calculating a total variance of noise of the predetermined tiles and a variance of each of the predetermined tiles according to the measured noise, comparing the calculated total variance with a first threshold, and comparing the variance of each tile with a second threshold; and
calculating a Log Likelihood Ratio (LLR) using a predetermined value according to the comparison result, and then performing decoding using the calculated LLR.

2. The method of claim 1, wherein the calculating of the LLR comprises calculating a noise mean of a corresponding slot in a time zone of the transmission region, and calculating the LLR using the calculated noise mean of the corresponding slot, when the calculated total variance is less than the first threshold.

3. The method of claim 1, wherein the calculating of the LLR comprises comparing the variance of each tile with the second threshold when the calculated total variance is greater than the first threshold.

4. The method of claim 3, wherein the calculating of the LLR comprises calculating the LLR using noise of a corresponding tile whose variance is greater than the second threshold, when the calculated variance of each of the predetermined tiles is greater than the second threshold.

5. The method of claim 3, wherein the calculating of the LLR comprises calculating a noise mean of corresponding tiles whose variance is less than the second threshold and calculating the LLR using the calculated noise mean, when the calculated variance of each of the predetermined tiles is less than the second threshold.

6. The method of claim 1, wherein the calculating of the total variance of noise of the predetermined tiles and the variance of each of the predetermined tiles comprises calculating a noise mean of the predetermined tiles.

7. The method of claim 1, wherein the measuring of the noise of each of the predetermined tiles comprises measuring strength of a pilot signal transmitted over the predetermined tiles.

8. An apparatus for receiving data in a communication system, the apparatus comprising:
a measurer for receiving data from a transmitter over a transmission region including multiple tiles and for measuring noise of each of predetermined tiles among the multiple tiles;
a first calculator for calculating a total variance of noise of the predetermined tiles and a variance of each of the predetermined tiles according to the measured noise;
a decider for comparing the calculated total variance with a first threshold and for comparing the variance of each tile with a second threshold; and
a second calculator for calculating a Log Likelihood Ratio (LLR) using a predetermined value according to the comparison result.

9. The apparatus of claim 8, further comprising:
a third calculator for calculating a noise mean of a corresponding slot in a time zone of the transmission region when the calculated total variance is less than the first threshold, wherein the second calculator calculates the LLR using the noise mean calculated by the third calculator.

10. The apparatus of claim 8, wherein the decider compares the variance of each of the predetermined tiles with the second threshold when the calculated total variance is greater than the first threshold.

11. The apparatus of claim 10, wherein the second calculator calculates the LLR using noise of a corresponding tile whose variance is greater than the second threshold, when the calculated variance of each of the predetermined tiles is greater than the second threshold.

12. The apparatus of claim 10, further comprising:
a third calculator for calculating a noise mean of corresponding tiles whose variance is less than the second threshold when the calculated variance of each of the predetermined tiles is less than the second threshold, wherein the second calculator calculates the LLR using the noise mean calculated by the third calculator.

13. The apparatus of claim 8, wherein the first calculator calculates a noise mean of the predetermined tiles.

14. The apparatus of claim 8, wherein the measurer measures strength of a pilot signal transmitted over the predetermined tiles to measure noise of each of predetermined tiles.

15. A method for receiving data by a receiver in a communication system, the method comprising:
receiving data including a plurality of tiles from a transmitter over a transmission region;
measuring noise of two or more of the plurality of tiles;
calculating a total variance of noise of the two or more tiles and a variance of each of the two or more tiles according to the measured noise;
comparing the calculated total variance with a first threshold;
comparing the variance of each of the two or more tiles with a second threshold;
calculating a Log Likelihood Ratio (LLR) using a predetermined value according to the comparison result; and
decoding the received data using the calculated LLR.

16. The method of claim 15, wherein the calculating of the LLR comprises calculating a noise mean of a corresponding slot in a time zone of the transmission region and calculating the LLR using the noise mean of the corresponding slot, when the total variance is to be less than the first threshold.

17. The method of claim 15, wherein the calculating of the LLR comprises comparing the calculated variance of each of the two or more tiles with the second threshold when the calculated total variance is greater than the first threshold.

18. The method of claim 17, wherein the calculating of the LLR comprises calculating the LLR using noise of a corresponding tile whose variance is greater than the second threshold, when the calculated variance of each of the two or more tiles is greater than the second threshold.

19. The method of claim 17, wherein the calculating of the LLR comprises calculating a noise mean of corresponding tiles whose variance is less than the second threshold and calculating the LLR using the calculated noise mean, when the calculated variance of each of the two or more tiles is less than the second threshold.

20. The method of claim 15, wherein the calculating of the total variance of noise of the two or more tiles and a variance of each of the two or more tiles comprises calculating a noise mean of the two or more tiles.

21. The method of claim 15, wherein the measuring of the noise of each of the two or more tiles comprises measuring strength of a pilot signal transmitted over the two or more tiles.
